(19) United States
(12) Patent Application Publication
(10) Pub. No.: US 2015/0168253 A1
(43) Pub. Date: Jun. 18, 2015

(54) SENSING SYSTEM AND METHODS FOR DISTRIBUTED BRILLOUIN SENSING

(71) Applicant: Omnisens SA, Morges (CH)

(72) Inventors: Sanghoon Chin, Ecublens (CH); Luc Thevenaz, Grandevent (CH)

(21) Appl. No.: 14/407,774

(22) PCT Filed: Mar. 7, 2013
(86) PCT No.: PCT/EP2013/054652

§ 371 Date: Dec. 12, 2014

(30) Foreign Application Priority Data
Jun. 13, 2012 (EP) PCT/EP2012/061181

(51) Int. Cl. G01M 11/00; G01K 11/32; G01B 11/16

(52) U.S. Cl. CPC G01M 11/3109; G01B 11/16; G01K 11/32; G01K 2011/322

(57) ABSTRACT

Methods of performing a distributing sensing measurement included the steps of, modulating the frequency of one or more light signals output from one or more light sources, using one or more multi-level sequence of bits so that the one or more light signals are frequency modulated; using the one or more frequency modulated light signals to provide a pump signal and a probe signal; propagating the pump and probe signals along an optical fiber; using interactions between the pump and probe signal to perform a distributed sensing measurement. There is further provided corresponding sensing systems.

### FIELD OF THE INVENTION

The present invention concerns sensing systems and methods for carrying out distributed Brillouin sensing; and in particular to systems and methods which uses an aperiodic sequence of bits to randomly or pseudo-randomly modulate the frequency of a light signal which is output from a one or more light sources, a wherein a pump signal and probe signal are derived from the frequency modulated light signal(s).

### DESCRIPTION OF RELATED ART

In many fields of application, like pipeline, power cables, the use of measuring apparatuses to monitor continuously structural and/or functional parameters is well known. The measuring apparatuses can be applied also to the civil engineering sector, and in particular in the field of the construction of structures of great dimensions.

The measuring apparatuses are commonly used to control the trend over time of the temperature or of the strain, i.e. of the geometrical measure of the deformation or elongation resulting from stresses and defining the amount of stretch or compression along the fibre, of the respective structure. In more detail, these measuring apparatuses are suitable to give information of local nature, and they can be therefore used to monitor, as a function of the time, the temperature or the strain associated with a plurality of portions and/or of components of the engineering structure to be monitored, providing useful information on leak, ground movement, deformation, etc. of the structure.

Among the measuring apparatuses used to monitor the status of engineered or architectonic structures, the optoelectronic devices based upon optical fibres have a great significance. In particular, these apparatuses normally comprise an electronic measuring device, provided with an optical fibre probe which is usually in the order of a few tens of kilometres. In use, this optical fibre is coupled stably to or arranged integral to, and maintained substantially in contact with, portions of or components of the engineered structure, whose respective physical parameters shall be monitored. For example, this optical fibre can run along the pipes of an oil pipeline, or it can be immersed in a concrete pillar of a building, so that it can be used to display the local trend of the temperature or of the strain of these structures. In other words these optoelectronic devices comprise fibre optical sensors, i.e. sensors which use the optical fibre as the sensing element. Fibre optical sensors can be:
point sensors, wherein only one location along the optical fibre is made sensitive to the temperature and/or the strain;
quasi-distributed sensors or multiplexed sensors, wherein many point sensors are connected to each other by an optical fibre and multiplexed along the length of the fibre by using different wavelength of light for each sensor; or
distributed or fully distributed sensors, wherein the optical fibre is a long uninterrupted linear sensor.

These measuring instruments based upon optical fibres can be subdivided into various types depending upon both the physical quantity/ies they are suitable to measure and the physical principle used to detect this quantity/these quantities.

When a powerful light pulse of wavelength λ₀ (or frequency ν₀=c/λ₀, wherein c is the speed of light in vacuum), known as the pump, propagates through an optical fibre, a small amount of the incident power is scattered in every directions due to local non-homogeneities within the optical fibre. If the optical fibre is a single-mode fibre (SMF), i.e. a fibre designed for carrying a single ray of light (mode) only, then only forward and backward scattering are relevant since the scattered light in other directions is not guided. Backscattering is of particular interest since it propagates back to the fibre end where the laser light was originally launched into the optical fibre.

Scattering processes originate from material impurities (Raleigh scattering), thermally excited acoustic phonon (Brillouin scattering) or optical phonon (Raman scattering).

Distributing sensing techniques rely on the analysis of the backscattered signal created at different location along the fibre.

RAYLEIGH SCATTERING is the interaction of a light pulse with material impurities. It is the largest of the three backscattered signals in silica fibres and has the same wavelength as the incident light. Rayleigh scattering is the physical principle behind Optical Time Domain Reflectometry (OTDR).

BRILLOUIN SCATTERING is the interaction of a light pulse with thermally excited acoustic waves (also called acoustic phonons). Acoustic waves, through the elasto-optic effect, slightly, locally and periodically modify the index of refraction. The acoustic waves will occur due to the interaction of the light with the optical fiber, which cause molecular vibrations in the optical fiber which propagate along the optical fiber as an acoustic wave; however, due to the exponential decaying feature of acoustic wave amplitudes, the spectrum of the acoustic waves have a finite width as narrow as 30 MHz at the full width at the half maximum of the amplitude; the peak frequency of the acoustic waves is referred to as the Brillouin frequency of the optical fiber. These acoustic waves act as grating reflectors in fibers. The corresponding acoustic waves reflects back a small amount of the incident light and shifts its frequency (or wavelength) due to the Doppler Effects. The shift in frequency depends on the propagation velocity of the generated acoustic wave in the fibre. Thus, Brillouin backscattering is created at two different frequencies around the incident light; at Brillouin frequency below and above the frequency of the incident light, called the Stokes and the anti-Stokes components, respectively. The spectrum of the backscattered light has also a finite width as narrow as the spectrum of the acoustic wave, hence 30 MHz at the full width at the half maximum of the amplitude. In silica fibres, the Brillouin frequency shift is in the 11 GHz range (0.1 nm in the 1550 nm wavelength range) and is temperature and strain dependent.

RAMAN SCATTERING is the interaction of a light pulse with thermally excited atomic or molecular vibrations (optical phonons) and is the smallest of the three backscattered signals in intensity. Raman scattering exhibits a large frequency shift of typically 13 THz in silica fibres, corresponding to 100 nm at a wavelength of 1550 nm. The Raman Anti-Stokes component intensity is temperature dependent whereas the Stokes component is nearly temperature insensitive.

FIG. 8 schematically shows a spectrum of the backscattered light generated at every point along the optical fibre when a laser light is launched in the optical fibre. The higher peak, at the wavelength λ₀, corresponding to the wavelength of a single mode laser, is the Rayleigh peak, originated from material impurities. The so-called Stokes components and the so-called anti-Stokes components are the peaks at the right side respectively left side of the Rayleigh peak. The anti-Stokes Raman peak, originated from atomic or molecular vibrations, has an amplitude depending on the temperature T. The Stokes and anti-Stokes Brillouin peaks, generated from thermally excited acoustic waves, have a frequency depending on the temperature T and on the strain ε.

The Brillouin frequency shift (wavelength position with respect to the original laser light) is an intrinsic physical property of the fibre material and provides important information about the strain and temperature distribution experienced by an optical fibre.

The frequency information of Brillouin backscattered light can be exploited to measure the local temperature or strain information along an optical fibre. Standard or special single-mode telecommunication fibres and cables can be used as sensing elements. The technique of measuring the local temperature or strain is referred to as a frequency-based technique since the temperature or strain information is contained in the Brillouin frequency shift. It is inherently more reliable and more stable than any intensity-based technique, based on the Raman effect, which are sensitive to drifts, losses and variations of attenuations. As a result, the Brillouin based technique offers long term stability and large immunity to attenuation. The process of propagating a pulse of light into the optical fibre and measuring the backscattering signal is called Spontaneous Brillouin Scattering (SPBS)-based optical time domain reflectometry (BOTDR): it is a weak processing which leads to a low intensity scattered light.

The Brillouin scattering process has the particularity that it can be stimulated by a second optical signal—called the probe signal—in addition to the first optical signal—called the pump signal—that generated the scattering, provided that the probe fulfils specific conditions, which is called phase matching conditions, that is, the frequency of the probe signal is placed within the spectrum of the spontaneous Brillouin scattering. When the probe signal is placed within the spectrum of the spontaneous Brillouin scattering, the beating signal at differential frequency between the pump and the probe signal reinforces the acoustic wave generated by thermally excited acoustic phonon. Then the reinforced acoustic wave stimulates Brillouin scattering process, hence the amount of Brillouin scattering through the SBS process is greatly enhanced compared to the spontaneous Brillouin scattering process, thus resulting in a larger signal to noise ratio (SNR). This property is especially interesting for sensing applications and can be achieved by the use of a probe counter propagating with respect to the pump. The Brillouin scattering process is maximized when pump and probe frequencies (or wavelengths) are exactly separated by the Brillouin frequency shift. When the probe signal is spectrally placed within the spectral region of Stokes components, Brillouin backscattering is stimulated from the pump signal to the probe signal and the optical power of the probe signal is amplified at the expense of the pump. Therefore, the probe signal experiences an optical gain, so-called Brillouin gain, and this configuration is referred to as Brillouin gain configuration. Optical gain is a calculated value, defined as the ratio of the optical power of the amplified probe signal after the SBS interaction to the initial optical power of the probe signal before the SBS interaction. When the probe signal is spectrally placed within the spectral region of anti-Stokes components, Brillouin backscattering is stimulated from the probe signal to the pump signal and the optical power of the probe signal is attenuated. Therefore, the probe signal experiences an optical loss, so-called Brillouin loss, and this configuration is referred to as Brillouin loss configuration. Optical loss is a calculated value, defined as the ratio of the optical power of the attenuated probe signal after the SBS interaction to the initial optical power of the probe signal before the SBS interaction. The Brillouin gain or loss that the probe signal can experience through the SBS interaction with the pump signal is a function of the frequency of the probe signal with respect to frequency of the pump signal due to the phase matching condition. Therefore, Brillouin gain or loss varies as the frequency of the probe signal is scanned with respect to the pump signal, following a Lorentzian shape. The maximum optical gain or loss that the probe signal can experience occurs when the frequency difference between the pump and the probe signals matches the local Brillouin frequency. So, the spectrum of Brillouin gain or loss is centered at Brillouin frequency below or above the frequency of the pump signal with Lorentzian shape and with a spectral width as narrow as 30 MHz at the full width at the half maximum of the amplitude.

Optoelectronic measurement devices based on stimulated Brillouin scattering (SBS) are known as Brillouin Optical Time Domain Analysers or BOTDA; as opposed to Brillouin Optical Time Domain Reflectometry (BOTDR) which are based on spontaneous Brillouin scattering (SPBS).

An optoelectronic measurement device based on BOTDA normally performs a frequency domain analysis and a time domain analysis.

Frequency domain analysis: the temperature/strain information is coded in the Brillouin frequency shift. Scanning the probe frequency with respect to the pump while monitoring the intensity of the probe signal allows to find the Brillouin gain or loss peak, and thus the corresponding Brillouin frequency shift, from which the temperature or the strain can be computed. This is achieved by using two optical sources to generate the pump signal and the probe signal, e.g. lasers, or a single optical source from which both the pump signal and the probe signal are created. In this case, a frequency shifter, e.g. external electro-optic modulator (EOM) (typically a telecommunication component), is used to scan the probe frequency in a controlled manner. An external electro-optic modulator (EOM) is a modulator which is configured to modulate light after it has been emitted from the light source; this is the opposite to direct light modulation whereby the light source is directly modulated so that the output of the light source is modulated.

Time domain analysis: due to the pulsed nature of the pump, the pump/probe interaction takes place at different location along the fibre at different times. For any given location, the portion of probe signal which interacted with the pump arrives on a detector after a time delay equal to twice the travelling time from the fibre input to the specified location. Thus, monitoring the intensity of the probe signal with respect to time, while knowing the speed of light in the fibre, provides information on the position where the scattering took place.

Thus, In BOTDR and BOTDA systems, an acoustic wave is generated, which propagates through a sensing fiber. The frequency of the probe signal is scanned to obtain distributed Brillouin gain or loss spectrum (BGS or BLS) along the length of the sensing optical fiber. In other words, the stimulated Brillouin scattering interaction between the pump signal (a pulsed signal) and probe signal (continuous wave) leads to an acoustic wave, so the acoustic wave exists along the whole length of the sensing optical fiber for the pulse duration (i.e. for each duration of the pulse of the pump signal).

In contrast in Brillouin optical correlation-domain analysis an acoustic wave is localised along a particular part of a sensing fiber through the stimulated Brillouin scattering interaction between the pump and the probe signals, and the frequency of the probe signal is scanned with respect to the pump, in order to obtain local Brillouin gain spectrum at the particular position, at which the acoustic wave is positioned, referred to as correlation peak. In this technique, the pump and probe signals are both continuous waves, but their frequencies are temporally modulated. Then the modulation frequency of pump and probe signals is a key to move the acoustic wave position along the length of the sensing optical fiber. So, Brillouin optical correlation-domain analysis is a point by point measurement and requires localised acoustic waves.

Brillouin optical correlation-domain analysis (BOCDA) can be seen as a distributed sensing system with high spatial resolution, which can readily reach a sub-cm spatial resolution, by changing the pump and probe modulation frequencies to move the local sensing point along the length of the sensing fibre whilst performing Brillouin analysis. However, the maximal number of sensing points is inherently restricted to several hundred, which disadvantageously limits the sensing range over which a high spatial resolution can be achieved. FIG. 1 depicts a schematic diagram of the conventional BOCDA sensing system 1.

The BOCDA sensing system 1 comprises a light source 3 (e.g. distributed feedback (DFB) laser diodes) which is driven by an injection current ‘I’ to output a light signal 5; the amplitude of the injection current ‘I’ is typically modulated with a sinusoidal waveform, so the optical frequency of the light signal 5, which is output from the light source 3, oscillates in time following the sinusoidal waveform. The injection current ‘I’ is typically provided by a function generator 16.

The light signal 5 is then split between a first and second optical branch 7,9; to provide a pump signal 11 in the first branch 7 and a probe signal 13 in the second branch 9. A sensing optical fiber 19 is further provided; the first and second optical branches 7,9 each terminate at the sensing optical fiber 19. The sensing optical fiber 19 is secured to a structure 18, so that temperature and strain within that structure 18 can be monitored.

The first branch 7 comprises a delay line 15 (e.g. a 1 km-long optical fiber); the pump signal 11 passes through a delay line 15 before being delivered to the sensing optical fiber 19. A delay line 15 can be placed within the second branch 9 instead of the first branch 7; the probe signal 13 passes through a delay line 15 before being delivered to the sensing fiber 19, now shown in FIG. 1. A delay line is to make the path lengths of the first and second branches unbalanced.

As discussed acoustic waves are required to stimulate Brillouin scattering (i.e. to achieve sufficient SBS interaction between the pump and probe signals 11,13). The generation of acoustic waves requires strict phase matching conditions for the pump and probe signals 11,13. The pump and the probe signals 11,13 must be spectrally separated by Brillouin frequency. A zeroth order correlation peak is a correlation peak which does not move as the frequency of the sinusoidal wave is changed. A zeroth-order correlation peak will occur if the optical path length of the first and second branches 7,9 are equal, and the delay line 15 ensures that this is not the case. The delay line 15 will prevent the occurrence of a zeroth-order correlation peak as the delay lines 15 will ensure that the optical path lengths of the first and second branches 7,9 differ.

An external modulator 21 is provided along the second branch 9. The external modulator 21 is configured to shift the frequency of the probe signal 13 so that, at the correlation peaks 23 (shown in FIG. 2), the frequency of the probe signal 13 can be scanned with respect to the frequency of the pump signal 11, over the vicinity of the Brillouin frequency of the sensing fiber 19. As discussed, the SBS process between the pump and probe signals 11,13 leads to efficient Brillouin backscattering from the pump signal 11 to the probe signal 13 (referred to Brillouin gain configuration) or vice and versa (Brillouin loss configuration). The optical power of the probe signal 13 when it exits the sensing fiber 19 after the SBS interaction with the pump signal 11 is measured using an optical power meter or a photo-detector for each frequency of the probe signal 13 while scanning the frequency of the probe signal 13. As a result, the Brillouin gain spectrum at each of the correlation peaks 23 can be interrogated. Then the frequency of the probe signal 13 at which the probe signal 13 experienced the maximum optical amplification or attenuation is used to determine the local Brillouin frequency at the correlation peak 23 in the sensing fiber 19; the frequency difference between the pump signal 11 and the probe signal 13 is determined to be the local Brillouin frequency.

The Brillouin frequency of the sensing optical fiber 19 has a linear dependence on temperature and strain of the sensing optical fiber 19, so that a change in Brillouin frequency can represent the change in temperature and strain of the structure 18. Typically, the relationship between the Brillouin frequency of the sensing optical fiber 19 and temperature is 1 MHz/° C. and the relationship between the Brillouin frequency of the sensing optical fiber 19 and strain is 1 MHz/20με, wherein ε is the amount of axial elongation or compression of the sensing optical fiber 19. The relationship between the Brillouin frequency of the sensing optical fiber 19 and temperature and the relationship between Brillouin frequency of the sensing optical fiber 19 and strain are, in general, obtained during a calibration step in which the Brillouin frequency of the sensing fiber 19 is measured when the sensing fiber 19 is at a series of known temperatures and strains for the response of Brillouin frequency on temperature or strain. Using the data obtained in the calibration step any change in temperature and/or strain can be determined from the measured Brillouin frequency of the sensing optical fiber 19. Moreover, when the sensing optical fiber 19 is attached to a structure 18 the optical fiber 19 will have the same temperature and strain as is in the structure 18; accordingly any changes in strain and temperature which occur in the structure 18 will cause a corresponding change in temperature and strain in the sensing optical fiber 19; thus the temperature and strain of the structure 18 can be determined from the Brillouin frequency of the sensing optical fiber 19.

Thus in summary by monitoring the optical power of the probe signal 13 as scanning the frequency of the probe signal 13, the frequency of probe signal 13 at which the maximum optical amplification or attenuation for the probe signal 13 occurs can be determined. At this frequency the Brillouin frequency of the sensing optical fiber 19 can be determined from the difference between the frequency of the probe signal 13 at which the maximum optical amplification or attenuation for the probe signal 13 occurs and the frequency of the pump signal 11. Using the Brillouin frequency of the sensing optical fiber 19 any change in temperature and strain within the sensing optical fiber, and thus within the structure 18 to which the sensing optical fiber 19 is attached, can be measured from the data obtained in the calibration step in which the relationship between temperature and strain and Brillouin frequency of the sensing optical fiber 19 was determined.

The Brillouin frequency of the sensing optical fiber 19 can be pre-calibrated at one or more known temperatures, so that the measured Brillouin frequency of the sensing optical fiber 19 can be directly converted to absolute temperature and strain applied to the structure 18 using the known linear relationship between Brillouin frequency of the sensing optical fiber 19 and temperature and strain.

The sensing system 1 comprises a detector 14. The detector 14 is configured to receive the probe signal 13, so as to measure the optical power of the probe signal 13 while scanning the frequency of the probe signal 13. Then the Brillouin frequency at the correlation peaks 23 can be determined, from which the temperature or the strain at the correlation peaks 23 along the sensing optical fiber 19 can be computed.

FIG. 2 depicts the instantaneous frequency of the pump signal 11 and probe signal 13, while propagating through the sensing optical fiber 19. At particular positions along the sensing fiber 19, the differential frequency between the pump signal 11 and probe signal 13 remains constant, so when the differential frequency is equal to the Brillouin frequency shift of the particular position along the sensing optical fiber 19, strong acoustic waves 24 are generated at those positions, which greatly enhance the Brillouin scattering from the pump signal 11 to the probe signal 13 (Brillouin gain configuration) or vice and versa (Brillouin loss configuration). The portions of the sensing optical fiber at which the acoustic waves 24 are present and localized are referred to as correlation peaks 23. By measuring the optical power of the probe signal 13 after the SBS interaction with the pump signal 11 with respect to the frequency of the probe signal the Brillouin frequency at correlation peaks 23 can be computed from the frequency at which the probe signal 13 experiences the maximum optical amplification or attenuation. At the other portions along the length of the sensing optical fiber 19, the relative frequency between the pump and probe signals varies in time, so the differential frequency between the pump signal 11 and probe signal 13 is not equal to the Brillouin frequency shift of the sensing optical fiber 19. Consequently, acoustic waves are not sufficiently generated through the stimulated Brillouin scattering interactions in regions outside the correlation peak positions 23, resulting in a negligible amount of Brillouin backscattering. Thus, Brillouin measurements which are taken by the detector 14 will only indicate conditions at the correlation peak positions 23.

The Brillouin frequency over the whole length of the sensing optical fiber 19 can be achieved by moving the correlation peak positions 23 along the length of the sensing optical fiber 19 so that the localized acoustic waves 24 are moved along the length of the sensing optical fiber 19; this is achieved by varying or scanning the frequency of the sinusoidal wave which defines the injection current ‘I’ to the light source 5. This way the distributed temperature and/or strain can be interrogated along the entire length of the optical sensing fiber 19, in this manner the temperature and strain over the entire length of the structure 18 can be determined.

In the sensing system 1 the physical length of each acoustic waves 24 corresponds to the spatial resolution (Δz) of the system; the spatial resolution (Δz) of the system is expressed as:

$$Δ z = \frac{{V}_{g} \cdot Δ {v}_{B}}{2 π \cdot {f}_{mod} \cdot Δ f} , \qquad ( 1 )$$

wherein V_{g} is the light signal velocity in the sensing optical fiber 19, Δν_{B} is the spectral width at the full width at half maximum of the spectrum of Brillouin scattering resulting from the SBS process when the pump and probe signals are both continuous wave (CW) or quasi-CW, showing typically 30 MHz in standard optical fibers. Δf is the modulation depth or the amount of maximum frequency variation of the pump and probe signals 11,13 and f_{mod} is the modulation frequency or the frequency of the sinusoidal wave which defines the injection current ‘I’ to the light source 5.

However, as shown in FIG. 2, the acoustic waves 24 appear periodically along the optical sensing fiber 19, which limits the maximal achievable sensing range. The distance between two adjacent acoustic waves dₘ is given by:

$${d}_{m} = \frac{{V}_{g}}{2 {f}_{mod}} . \qquad ( 2 )$$

Comparing equations 1 and 2, it is clear that the sensing range dₘ can be improved to a finite extent, simply by decreasing the modulation frequency f_{mod}, but that a decrease in the modulation frequency f_{mod} leads to a significant increment of the spatial resolution (Δz) of the system. Consequently, the sensing data points, defined as the ratio of the sensing range to the spatial resolution (dₘ/Δz), is restricted to several hundred in this type of sensing system.

Thus, in conventional BOCDA systems, the spatial resolution can be improved by simply increasing modulation depth Δf, as shown in Eq. (1). However, it turns out that the increment of Δf leads to several practical problems in terms of signal-to-noise ratio. Large modulation depth requires an appropriate optical filtering system to precisely select only probe signal. In addition, when the modulation depth is larger than a Brillouin frequency shift, the spectrum of Brillouin pump and probe signals will start to overlap. This spectral overlapping makes it impossible to select only the probe signal in detection system, leading to a significant noise imposed onto the signal to be detected.

Systems and method have been proposed to enhance the sensing range while preserving the spatial resolution. One such system is shown in FIG. 3. FIG. 3 provides a schematic diagram of a sensing system 30 which achieves decoupling of the spatial resolution and sensing range parameters.

The sensing system 30 shown in FIG. 3 has many of the same features of the system 1 shown in FIG. 1, and like features are awarded the same reference numerals.

The system 30 comprises an external modulator 31 (external electro-optic phase modulator) which is configured to modulate the optical phase of a light signal 37 which is output from a light source 33. The external modulator 31 is driven by a pseudo-random binary sequence (PRBS) generator 35, so that the optical phase of the light signal 37 is temporally modulated following the applied PRBS modulation pattern to provide a phase-modulated light signal 39. The PRBS modulation pattern comprises ‘N’ number of bits (symbols), which have a time duration of ‘T’; and 1/T corresponds to the modulation frequency f_{mod} in the system 1. The phase-modulated light signal 39 is split to provide a pump signal 43 and probe signal 41 in a first and second optical branch respectively 7,9, respectively.

Thus, the probe signal 41 and pump signal 43 which are derived from the phase-modulated light signal 39 have each effectively been phase-modulated with an identical modulation pattern provided by the external modulator 31, which is driven by a pseudo-random binary sequence (PRBS) generator 35; this ensures that the acoustic waves are confined to particular positions along the sensing optical fiber 19.

FIG. 4 depicts the instantaneous optical phase of the pump signal 43 and probe signal 41, while propagating through the sensing optical fiber 19. Like in a typical BOCDA scheme, the modulation pattern leads to correlation peaks 23 along a sensing fiber 19, where the optical phases of the probe and the pump signals 41,43 remains identical over time. So, the acoustic waves are continuously reinforced through the SBS interaction, hence resulting in strong acoustic waves 24 at the correlation peaks 23.

Then the acoustic waves 24 can be displaced along the sensing fiber 19 by changing the time duration T of each of the symbols, thus changing the modulation frequency f_{mod} i.e. 1/T. Unlike in typical BOCDA scheme, the differential frequency between the probe and the pump signals 41,43 remains constant in this scheme, equal to Brillouin frequency of the sensing fiber 19. So, the probe and pump signals 41,43 mutually interact through stimulated Brillouin scattering to generate acoustic waves all along the sensing optical fiber 19. However, the optical phases of the probe and the pump 41,43 are pseudo-randomly altered between zero and π-phase with a periodicity of T and the amplitude sign of the generated acoustic waves is determined by the pump and probe phases. For instance, when the probe and the pump signals 41,43 are in phase (both either zero or π-phase) the amplitude sign of the generated acoustic wave is positive, but when the optical phase of the probe and the pump signals 41,43 are different to be zero and π-phase, respectively or vice and versa, the acoustic wave has a negative sign in amplitude. Thus the acoustic wave outside correlation peaks 23 vanishes since the time average of the acoustic wave amplitude comes to zero.

As can be seen in FIG. 4, at correlation peaks 23 the probe and pump signal 41,43 remain in phase, so acoustic waves 24 can be efficiently constructed at those points. The physical effective length of the correlation peak, corresponding to the spatial resolution Δz, is determined as Δz=0.5×V_{g}×T. The spectral property of the acoustic waves 24 at the correlation peaks 23 can be measured by scanning the frequency of the probe signal 41 like in the conventional BOCDA systems.

PRBS is a bit sequence of random binary modulation, consisting of N number of binary bits (or symbols), but the modulation pattern is repeated by the length of PRBS, as shown in FIG. 4. So, the physical distance between two adjacent correlation peaks dₘ is given as

$${d}_{m} = N \cdot \frac{1}{2} \cdot {V}_{g} \cdot T = N \cdot Δ z . \qquad ( 3 )$$

As clearly seen in Equation (3), the code periodicity, that is the product of the number of bits in PRBS N and the spatial resolution Δz, determines the sensing range. The two parameters: N and Δz are thus independent, so that sensing system 30 can achieve high resolution over a long range.

Disadvantageously, the sensing system 30 requires an external modulator 31 (external electro-optic phase modulator), which is expensive and bulky.

Additionally since the sensing system 30 requires exact π-phase shift of the light signal output from the light source 33 through an external modulator 31, an electrical amplifier would be required since the output from the external modulator 31, which is driven by a pseudo-random binary sequence (PRBS) generator 35, alone would not be sufficient to achieve π-phase modulation of the light signal output from the light source 33. However, in case of failure to achieve exact π-phase modulation or to stabilize the π-phase shift in time, the average amplitude over time of the acoustic wave outside the correlation peaks 23 will result in a residual acoustic wave along the entire sensing fiber 19. The residual acoustic waves diffract the pump signal 43 not only at the correlation peaks 23, but also all along the sensing fiber 19, which imposes a significant noise onto the probe signal where the temperature/strain information is coded, hence degrading the sensing performance.

In other aspect, the optical phase modulation through an external phase modulator can be converted to the intensity modulation when the intrinsic fiber dispersion is large enough. In such conditions, the pump and the probe signals 41,43 are no longer continuous waves, but turn to be intensity-modulated. This conversion of phase-modulation to intensity-modulation will impair the sensing system since the system requires continuous wave probe and pump signals 41,43. Besides, when multi-Gbit rate PRBS modulation is required to achieve a high spatial resolution an appropriate electrical amplifier must be accompanied to obtain exact π-phase modulation which would be practically difficult or costly.

There is a need in the art for a distributed sensing system and method wherein a high spatial resolution can be achieved over longer sensing ranges, without the requirement for additional expensive equipment.

It is an aim of the present invention to obviate or mitigate one or more of the aforementioned disadvantages.

### BRIEF SUMMARY OF THE INVENTION

According to the invention there is provided a method of performing a distributed sensing measurement, comprising the steps of, modulating the frequency of one or more light signals output from one or more light sources, using one or more multi-level sequence of bits so that the one or more light signals are frequency modulated; using the one or more frequency modulated light signals to provide a pump signal and a probe signal; propagating the pump and probe signals along an optical fiber; using interactions between the pump and probe signal to perform a distributed sensing measurement.

The interactions between the pump and probe signal may be used to perform the Brillouin scattering measurement in the same manner as is done in the prior art (described above).

The pump and probe signal interact in the optical fiber to stimulate Brillouin backscattering from the pump to the probe, or vice or versa, through the stimulated Brillouin scattering process, resulting in an optical amplification or an optical attenuation for the probe signal. When the frequency of the probe signal is scanned with respect to the pump signal the optical power of the probe signal is measured, using optical power meter or photo-detector. When the frequency of the probe signal is in the vicinity of the region of Brillouin Stokes components or anti-Stokes components the probe signal experiences an optical amplification (Brillouin gain configuration) or an optical attenuation (Brillouin loss configuration), respectively. The frequency of the probe signal at which the probe signal experienced the maximum optical amplification or attenuation occurs is used to determine the Brillouin frequency. The difference between the frequency of the pump signal and the frequency of the probe signal at which the the probe signal has a maximum optical amplification or attenuation, corresponds to the Brillouin frequency of the optical fiber. Using a known relationship between Brillouin frequency of the optical fiber and temperature and strain within the optical fiber, the temperature and strain of within the optical fiber, and thus within the structure to which the optical fiber is attached, can be determined. As discussed the relationship between Brillouin frequency of the optical fiber and temperature and strain within the optical fiber can be determined based on a calibration step in which the Brillouin frequency of the optical fiber is measured when the optical fiber is at known temperatures and strains.

It should be remembered that when the frequency of the probe signal is within the spectral region of Stokes components, Brillouin backscattering is stimulated from the pump signal to the probe signal and the optical power of the probe signal is amplified at the expense of the pump. This is caused by the transfer of photons from the pump signal to the probe signal. Therefore, the probe signal experiences an optical amplification (so-called Brillouin gain, and this configuration is referred to as Brillouin gain configuration). Optical amplification is a calculated value, defined as the ratio of the optical power of the amplified probe signal after the stimulated Brillouin backscattering has occurred to the initial optical power of the probe signal before the stimulated Brillouin backscattering occurred. The difference between the frequency of the pump signal and the frequency of the probe signal at which the probe signal has a maximum optical amplification corresponds to the Brillouin frequency of the optical fiber. It will be understood that when the optical amplification of the probe signal is a maximum, the power of the probe signal will also be at a maximum.

When the frequency of the probe signal is within the spectral region of anti-Stokes components, Brillouin backscattering is stimulated from the probe signal to the pump signal and the optical power of the probe signal is attenuated. This is caused by the transfer of photons from the probe signal to the pump signal. Therefore, the probe signal experiences an optical attenuation (so-called Brillouin loss, and this configuration is referred to as Brillouin loss configuration). Optical attenuation is a calculated value, defined as the ratio of the optical power of the attenuated probe signal after the stimulated Brillouin backscattering has occurred to the initial optical power of the probe signal before the stimulated Brillouin backscattering has occurred. The difference between the frequency of the pump signal and the frequency of the probe signal at which the probe signal has a maximum optical attenuation corresponds to the Brillouin frequency of the optical fiber. It will be understood that when the optical attenuation of probe signal is a maximum, the power of the probe signal will also be at a minimum.

The optical amplification or attenuation that the probe signal can experience through the stimulated Brillouin backscattering with the pump signal is a function of the frequency of the probe signal with respect to frequency of the pump signal due to the phase matching condition. Therefore, optical amplification or attenuation varies as the frequency of the probe signal is scanned with respect to the pump signal, following a Lorentzian shape. The maximum optical amplification or attenuation that the probe signal can experience occurs when the frequency difference between the pump and the probe signals matches the local Brillouin frequency of the optical fiber. So, the spectrum of the optical amplification or attenuation of the probe signal is centered at Brillouin frequency below or above the frequency of the pump signal with Lorentzian shape and with a spectral width as narrow as 30 MHz at the full width at the half maximum of the amplitude.

So the interaction between the pump signal and the probe signal through the stimulated Brillouin scattering process manifests the variation in optical power of the probe signal, since the probe signal experiences an optical amplification or attenuation through the SBS interaction with the pump signal, depending on Brillouin gain configuration and loss configuration, respectively. The amount of optical amplification or attenuation can be converted to optical gain (so-called Brillouin gain) or optical loss (so-called Brillouin loss). The Brillouin gain or loss is calculated from the ratio of the optical power of the amplified or attenuated probe signal to the initial optical power of the probe signal before the SBS interaction. Brillouin gain or loss that the probe signal experiences is a function of the frequency of the probe signal with respect to the pump signal; and the frequency of the probe signal at which the probe signal experiences the maximum Brillouin gain or loss is used to determine the Brillouin frequency of the fiber. The frequency difference between the frequency of the pump signal and the frequency of the probe signal corresponding to the maximum Brillouin gain is determined to be Brillouin frequency of the fiber. Therefore, the Brillouin frequency of the optical fiber can be readily obtained as the frequency of the probe signal is scanned with respect to the frequency of the pump signal and detecting the intensity of the probe signal, using optical power meter or photo-detector. It should be noted that ‘intensity’ is the optical power divided by the area in which light is confined in fibers, so that the intensity of the probe signal is the optical power of the probe signal divided by the area, which is constant along the fiber.

It will be understood that the optical fiber mentioned above is preferably a sensing optical fiber.

The performed distributed sensing measurement can then lead to temperature and pressure measurement along a structure as is done in the prior art (described above).

The Brillouin frequency is an intrinsic property of the optical fiber, which has a linear dependence on the temperature and strain of the fiber. The Brillouin frequency changes proportionally with respect to change in temperature and strain applied to the optical fiber, typically showing linear relationship of 1 MHz/° C. and 1 MHz/20με for temperature and strain, respectively. ε is the amount of axial elongation or compression of the optical fiber. The relationship between the Brillouin frequency of the optical fiber and temperature and strain is preferably obtained in a calibration step in which the Brillouin frequency of the optical fiber is measured when the optical fiber is at known temperatures and strains. A function representing the relationship between the Brillouin frequency of the optical fiber and temperature and strain can be determined from the calibration results. The Brillouin frequency of the fiber that is installed along a structure under monitoring is continuously measured and any changes in the measured Brillouin frequency can represent changes in temperature and strain of the structure. The linear relationship between Brillouin frequency of the fiber and temperate and strain is thus obtained from this calibration step, to get the linear thermal or strain coefficients of Brillouin frequency in unit of MHz/° C. or MHz/με, ε being axial elongation or compression of the fiber.

A further step to measure Brillouin frequency of an optical fiber, which has been secured or installed along the structure, at one or more known temperatures or strains of the structure can be performed in a further pre-calibration process. In this further pre-calibration process the Brillouin frequency of the optical fiber is determined when the structure is at a series of known temperatures and strains. Thus the relationship between the temperature and strain in the structure to Brillouin frequency of the optical fiber can be determined; such a relationship is necessary to know so that the absolute temperature change and absolute strain change in the structure can be determined. Based on the pre-calibration process, the measured Brillouin frequency of the fiber can be converted to absolute temperature and/or strain of the structure, so that absolute temperature and/or strain can be continuously monitored.

The method comprises the step of modulating the frequency of a light signal output from a light source using a multi-level sequence of bits so that the light signal is frequency modulated to provide a frequency modulated light signal; and the step of using the one or more light signal to provide a pump signal and a probe signal comprises splitting said frequency modulated light signal to provide a pump signal and a probe signal. Preferably the light source is a single light source. Accordingly there is provided a method of performing a distributing sensing measurement, comprising the steps of, modulating the frequency of a light signal output from a light source using a multi-level sequence of bits so that the light signal is frequency modulated to provide a frequency modulated light signal; splitting the frequency modulated light signal to provide a pump signal and a probe signal; propagating the pump and probe signals along an optical fiber; using the interactions between the pump and probe signal to perform distributed sensing measurements. Preferably the light source is a single light source.

Preferably the multi-level sequence of bits is a multi-level aperiodic sequence of bits.

Sensing may be performed similarly to prior art described previously; accordingly the frequency modulation of the pump and the probe signals results in correlation positions, where the frequency of the pump and the probe remains constant. Only at correlation positions the SBS interaction between the pump and the probe occur efficiently. So, Brillouin analysis at those positions provides a change in environmental conditions such as temperature and strain.

The method may further comprise the step of changing the modulation frequency to change a position of a correlation peak. Preferably, the modulation frequency is changed so that correlation peak is moved along the entire length of the sensing fiber so that distributed temperature and or strain along the sensing fiber can be measured.

Modulating the frequency of a light signal output from a light source using a multi-level aperiodic sequence of bits can overcome the inevitable trade-off relation between spatial resolution and sensing range, which is a major limitation in typical BOCDA systems, without modifying the implementation of the typical BOCDA systems.

Such frequency modulation scheme does not require any expensive external electro-optic phase modulator and/or electrical components such as high power microwave amplifier to improve the sensing range while preserving the spatial resolution.

The step of modulating the frequency of a light signal output from a light source using a multi-level sequence of bits, may comprise using a frequency shifter, which can shift the frequency of the light signal output from the light source, using the multi-level sequence of bits.

Multi-level sequence of bit is a time series of bit consisting of N number of bits. The amplitude of each bit can be any value within k different levels; k is an integer, i.e. when k=2 it is referred to as binary sequence.

Preferably the light signal is modulated to have an aperiodic pattern of frequency.

Preferably, the multi-level aperiodic sequence of bits is a binary aperiodic sequence of bits. However, it will be understood that any other number of levels may be used.

The multi-level aperiodic sequence of bits may be a chaotic multi-level aperiodic sequence of bits. ‘Chaotic’ means random and without any repetition.

The step of modulating the frequency of a light signal output from a light source may comprise modulating an injection current which operates the light source using a binary aperiodic sequence of bits.

The step of modulating an injection current which operates the light source using a binary aperiodic sequence of bits may comprise multiplying the injection current by the binary aperiodic sequence of bits.

When a constant current is applied to a light source, the light source emits a light signal at a fixed frequency. In this case, the injection current is a constant current. In the present invention, the injection current is made of multiplication of a constant current and PRBS. So, the injection current is modulated by the PRBS on the base of the constant current value.

The method may comprise the step of modulating the frequency of a first light signal output from a first light source using a first multi-level sequence of bits to provide a first frequency modulated light signal, and modulating the frequency of a second light signal output from a second light source using a second multi-level sequence of bits, to provide a second frequency modulated light signal; using the first frequency modulated light signal as the pump signal and using the second frequency modulated light signal as the probe signal. According to the invention there is provided a method of performing a distributing sensing measurement, comprising the steps of, modulating the frequency of a first light signal output from a first light source, using a first multi-level sequence of bits, to provide a pump signal; modulating the frequency of a second light signal output from a second light source, using a second multi-level sequence of bits, to provide a probe signal; propagating the pump and probe signals along an optical fiber; using the interactions between the pump and probe signal to perform a distributed sensing measurement

The first multi-level sequence of bits may be equal to the second multi-level sequence of bits.

Preferably the multi-level sequence of bits is a multi-level aperiodic sequence of bits.

Sensing may be performed similarly to prior art described previously; accordingly the frequency modulation of the pump and the probe signals results in correlation positions, where the frequency difference between the pump and the probe remains constant. Only at correlation positions the SBS interaction between the pump and the probe occur efficiently. So, Brillouin analysis at those positions provides a change in environmental conditions such as temperature and strain.

The frequency of the one or more light signals may be modulated at frequency referred to as a modulation frequency f_{mod}. The method may further comprise the step of changing the modulation frequency f_{mod} to change the position of a correlation peak. Preferably, the modulation frequency f_{mod} is changed so that a correlation peak is moved along the entire length of the sensing optical fiber so that distributed temperature and or strain along the sensing fiber can be measured.

The step of modulating the frequency of the first light signal output from the first light source using a first multi-level sequence of bits, may comprise using a first frequency shifter, which can shift the frequency of the first light signal output from the first light source, using the first multi-level sequence of bits. The step of modulating the frequency of the second light signal output from the second light source using a second multi-level sequence of bits, may comprise using a second frequency shifter, which can shift the frequency of the second light signal output from the second light source, using the second multi-level sequence of bits.

Preferably the first and/or second light signals is/are modulated to have a aperiodic pattern of frequency.

Preferably, each of the first and second multi-level aperiodic sequence of bits are binary aperiodic sequences of bits. However, it will be understood that any other number of levels may be used.

The first and second multi-level aperiodic sequence of bits may each be a chaotic multi-level aperiodic sequence of bits. ‘Chaotic’ means random and without any repetition.

The step of modulating the frequency of the first light signal output from the first light source may comprise modulating a first injection current which operates the first light source using a binary aperiodic sequence of bits. The step of modulating the frequency of the second light signal output from the second light source may comprise modulating a second injection current which operates the second light source using a binary aperiodic sequence of bits.

The step of modulating an injection current which operates the first or second light sources using a binary aperiodic sequence of bits may comprise multiplying the injection current by the binary aperiodic sequence of bits.

The method may comprise the step of multiplying the first injection current with a first PRBS. The method may comprise the step of multiplying the first injection current with a second PRBS. The method may comprise the step of multiplying each of the first and second injection currents with a single PRBS.

Each of the methods described above may further comprise the following features or steps:

To achieve modulation of a light signal frequency, the intensity or phase of a light signal can be internally modulated using a modulator which is integral to the light source or laser.

To achieve modulation of a light signal frequency, the intensity or phase of a light signal can be externally modulated.

To achieve modulation of a light signal frequency, the intensity or phase of a light signal can be directly modulated by modulating the input current which operates the light source which provides the light signal.

Alternatively, or additionally, the modulation of a light signal frequency the intensity or phase of a light signal can be indirectly modulated (as opposed to directly modulating the light signal). In other words the light signal which is output from the light source is modulated to modulate the intensity or phase of the light signal.

An external electro-optic intensity and/or phase modulator can be used to generate light signals which have frequencies different from the frequency of the light signal it receives. The electro-optic intensity and/or phase modulator is ‘external’ as it is not integrated to the light source which provides the light signal. The external electro-optic intensity and/or phase modulator is driven with a voltage which has a frequency referred to as a microwave at frequency f_{RF}. When the light signal is sent into the external modulator that is driven by the voltage at microwave at frequency f_{RF}, the intensity and/or phase of the light signal at the output of the modulator is modulated at a frequency equal to the microwave frequency f_{RF}. In addition, the frequencies of the generated light signals are determined by the microwave frequency f_{RF} of the voltage applied to the external modulator, generating new light signals which have a frequency which is a frequency magnitude f_{RF} above, or a frequency magnitude f_{RF} below, the frequency of the light signal which the external modulator receives. The external electro-optic modulator may be configured or programmed to modulate the frequency of the generated light signals. For example, the frequency of the voltage (i.e. the microwave frequency f_{RF}) which is applied to the external electro-optic modulator may be temporally increased or decreased so as to temporally increase or decrease the frequency of the generated light signals, hence modulating the frequency (or phase) of the light signals generated at the external electro-optic modulator. When the frequency (i.e. the microwave frequency f_{RF}) of the voltage applied to the external electro-optic modulator is modulated using a multi-level sequence of bits, the frequency of the light signals which are generated by the external electro-optic modulator follows the pattern of the multi-level sequence of bits. It will be understood that the external electro-optic modulator may be used as an alternative to modulating the injection current to a light source, to achieve modulation of a light signal from a light source.

The binary aperiodic sequence may be PRBS.

The distributed sensing measurement may be preferably Brillouin sensing. The distributed sensing measurement may be Brillouin backscattering sensing.

The interaction between the first signal and the second signal through the stimulated Brillouin scattering process can occur with high efficiency at correlation peaks, so that either the first signal or the second signal will experience sufficient modification in intensity. The intensity variation will be maximized when the frequency difference between the first signal and the second signal is equal to the Brillouin frequency of a portion of the fiber in which the correlation peaks are present. Therefore, the local Brillouin frequency at the correlation peaks can be simply measured as scanning the frequency of the first (or second) signal with respect to the second (or first) signal and measuring the intensity of the first (or second) signal.

Other distributed sensing measurements may alternatively be performed; for example distributed sensing based on the synthesis of optical coherence function.

The method may further comprise the step of delaying a pump signal or probe signal. Preferably the method further comprises the step of delaying a pump signal or probe signal such that higher order correlation peaks are created along a sensing fiber. Higher order correlation peaks mean correlation peaks which are generated in the case when there is delay means present. The positions of the correlation peaks may be adjustable by adjustment of the modulation frequency. If the pump and probe signals are separately frequency-modulated, the position of the correlation peaks may be moved by introducing an electrical time delay in the frequency modulation process; in this configuration the modulation frequency is unchanged, but since one of two signals enters into the sensing fiber with a time delay, the correlation peaks will move by the half of time delay due to counter propagation.

According to a further aspect of the present invention there is provided a sensor system for performing a distributing sensing measurement, the sensor comprising, one or more light sources; a means for modulating the frequency of one or more light signals output from the one or more light sources using one or more multi-level sequence of bits, so that the one or more light signals are each frequency modulated; a means for providing a pump signal and a probe signal from the one or more frequency modulated light signals; a sensing optical fiber arranged so that the pump signal and probe signal can propagate through the optical fiber; a detection means which is configured to perform distributed sensing measurements based on interactions between the pump signal and probe signal in the optical fiber.

The sensor system may comprise a light source, and wherein the means for modulating is a means for modulating the frequency of a light signal output from said light source using a multi-level sequence of bits so that the light signal is frequency modulated; and wherein the means for providing the pump signal and probe signal may comprise a means for splitting the modulated light signal to provide a pump signal and a probe signal. Accordingly there is provided a sensor system for performing a distributing sensing measurement, the sensor comprising, a light source; a means for modulating the frequency of a light signal output from the light source using one or more multi-level sequence of bits, so that the light signal is frequency modulated; a means for splitting the frequency modulated light signal to provide a pump signal and a probe signal; a sensing optical fiber through which the pump signal and probe signal can propagate; a detection means which is configured to perform distributed sensing measurements based on interactions between the pump signal and probe signal in the sensing optical fiber.

Preferably the sensor system comprises a single light source.

The sensor system may comprise a light source operable by an injection current to output the light signal output, the frequency of the light signal output being a function of the injection current, and wherein the means for modulating the frequency of the light signal output may comprise a modulator which is configured to modulate the injection current provided to the light source using the multi-level sequence of bits, so that the light signal output which is output from the light source is frequency modulated.

The means for modulating the frequency of the light signal output from the light source may be configured to intermittently modulate the frequency of the light signal output from the light source.

The sensor system may comprise a first and second light source, wherein the means for modulating defines the means for providing the pump and probe signal, and wherein said means for modulating may comprise, a means for modulating the frequency of a first light signal output from the first light source, using a first multi-level sequence of bits, to provide a pump signal, and a means for modulating the frequency of a second light signal output from the second light source, using a second multi-level sequences of bits, to provide a probe signal. Accordingly the is provided a sensor system for performing a distributing sensing measurement, the sensor comprising, a first and second light source; a means for modulating the frequency of a first light signal output from a first light source, using a first multi-level sequence of bits, to provide a pump signal; a means for modulating the frequency of a second light signal output from a second light source, using a second multi-level sequence of bits, to provide a probe signal; a sensing optical fiber along which the pump signal and probe signal can propagate; a detection means which is configured to perform distributed sensing measurements based on interactions between the pump signal and probe signal in the sensing optical fiber.

The first and second light sources may operable by a injection current to output the first and second light signals respectively, the frequency of the first and second light signals being a function of the injection current, and wherein the means for modulating the frequency of the first light signal and the means for modulating the frequency of the second light signal may comprise a modulator which is configured to generate frequency modulated light signals the injection current provided to the first and second light sources using the multi-level sequence of bits, so that the first light signal output from the first light source is frequency modulated and the second light signal output from the second light source is frequency modulated. Preferably the injection current is provided by a single current source.

The first and second light source may operable by first and second injection currents to output the first and second light signals respectively, the frequency of the first and second light signals being a function of the first and second injection currents, and wherein the means for modulating the frequency of the first light signal may comprise a first modulator which is configured to generate one or more frequency modulated light signals using a first multi-level sequence of bits to modulate the frequency of the voltage which is used to drive the first modulator (the frequency of the voltage which is used to drive the first modulator is known as a first microwave frequency), and the means for modulating the frequency of the second light signal may comprise a second modulator which is configured to generate one or more frequency modulated light signals using a second multi-level sequence of bits to modulate the frequency of the voltage which is used to drive the second modulator (the frequency of the voltage which is used to drive the second modulator is known as the second microwave frequency) applied to the second modulator, so that the first and second light signals output from the first and second light sources is frequency modulated. The phase and/or intensity of the first and second light signals may be modulated.

A single modulator may define both the means for modulating the frequency of a first light signal output and the means for modulating the frequency of a second light signal output.

The first multi-level sequence of bits may be equal to the second multi-level sequence of bits.

The means for modulating the frequency of the first light signal output may be configured to intermittently modulate the frequency of the first light signal output and the means for modulating the frequency of the second light signal output may be configured to intermittently modulate the frequency of the second light signal output.

Any of the above-mentioned sensor systems may optionally comprise the following features:

The frequency of the light signal output from a light source may be proportional to the value of the injection current. For instance, if the injection current is swapped between two values, like a constant current is modulated by a PRBS, the frequency of the output light signal will flip between two frequencies.

The sensor system may further comprise a frequency shifter, which can shift the frequency of a light signal output from a light source, using the multi-level sequence of bits.

The multi-level sequence of bits may be a binary aperiodic sequence of bits.

The binary aperiodic sequence of bits may be PRBS.

The sensor system may further comprise a delay means which is configured to delay a pump signal or probe signal. Preferably the sensor system comprises a delay means which is configured to delay a pump signal or probe signal such that higher order correlation peaks are created along a sensing fiber. Higher order correlation peaks mean correlation peaks which are generated in the case when there is delay means present. The positions of the correlation peaks may be adjustable by adjustment of the modulation frequency.

The sensor system may further comprise a modulator which is configured to shift the frequency of the probe signal and/or pump signal so that the frequency difference between the probe and pump signal is equal to a Brillion frequency of the optical fiber.

The detection means may be configured to perform Brillouin sensing or Brillouin scattering analysis. The Brillouin sensing or Brillouin scattering analysis may be performed to measure, for example, temperature and or strain in the optical fiber.

The or each light source may be a coherent light source.

The one or more frequency modulated light signals can be used to create correlation peaks along a sensing fiber through a well-known technique referred to synthesis of optical coherence function (SOCF). One of the frequency modulated light signals is preferably used to provide a pump signal and another of the frequency modulated light signals is preferably used to provide a probe signal. Within correlation peaks the correlation between the pump and the probe signals remains high, resulting in high coherence between the two signals while the correlation between the pump and the probe signals remains fluctuated, resulting in low coherence. Therefore, by interrogating the degree of the coherence between the pump and the probe signals, any variation of physical properties, (e.g. temperature and strain) of a structure to which the sensing optical fiber is secured, can be detected.

BOCDA may be made based on SOCF technique, improving the performance of distributed sensing compared to SOCF-based sensing.

In the present invention the frequency of the light signal from the light source is preferably modulated using multi-level sequence of bits. The mutual interference (i.e. optical interaction) between the pump and the probe signals generates a beating signal at the differential frequency between the pump signal and the probe signal. When the differential frequency is equal to Brillouin frequency of the optical sensing fiber, the mutual interference between the pump and the probe signals reinforces an acoustic wave at the correlation peaks only, so as to greatly enhance the Brillouin scattering from the pump to the probe or vice and versa. However, when the frequencies of the pump and the probe signals are equal, the correlation between the two signals creates periodic correlation peaks along a sensing optical fiber, in which the frequencies of the pump and the probe signals remains equal, resulting in a high degree of coherence. The correlation between the pump and the probe signals along the rest of the sensing optical fiber (i.e. outside the correlation peaks) remains fluctuated, hence resulting in a low degree of coherence.

### BRIEF DESCRIPTION OF THE DRAWINGS

The invention will be better understood with the aid of the description of an embodiment given by way of example and illustrated by the figures, in which:

FIG. 1 shows a schematic diagram representing a sensing system belonging to the prior art;

FIG. 2 depicts the instantaneous frequency of the pump signal and probe signal while propagating through the sensing optical fiber of the sensing system of FIG. 1;

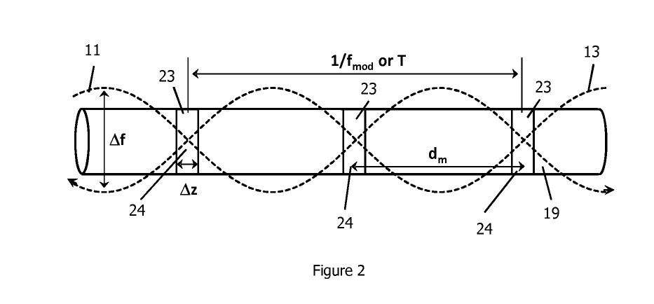

FIG. 3 shows a schematic diagram representing a second sensing system belonging to the prior art;

FIG. 4 depicts the instantaneous optical phase of the pump signal and probe signal while propagating through the sensing optical fiber of the sensing system of FIG. 3;

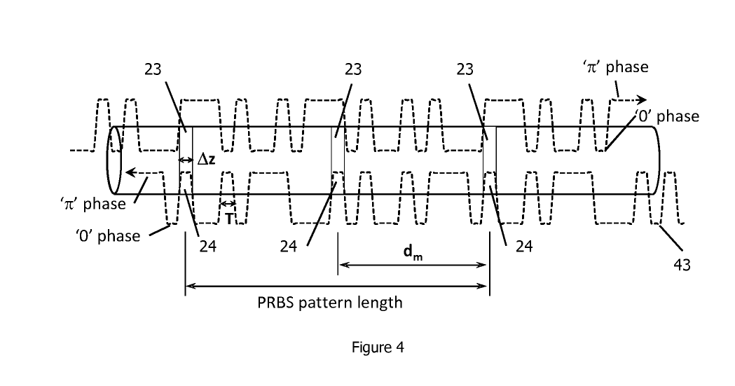

FIG. 5 provides a schematic diagram of a sensing system according to a first embodiment of the present invention;

FIG. 6 depicts the instantaneous frequency of the pump signal and probe signal while propagating through the sensing optical fiber of the sensing system of FIG. 5;

FIG. 7 provides a schematic diagram of a sensing system according to a further embodiment of the present invention;

FIG. 8 shows a view of the backscattered light components of a light launched in a single-mode optical fibre of an optical sensing system;

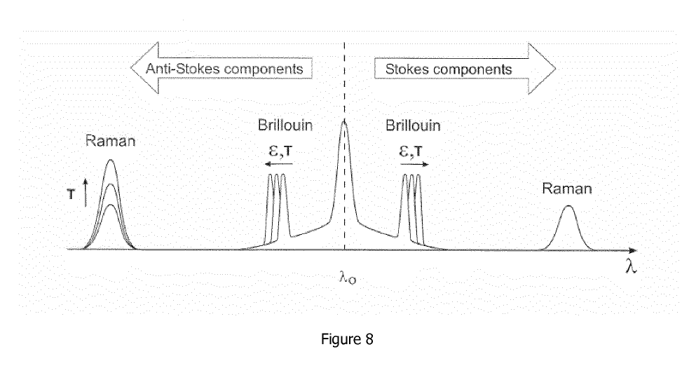

FIG. 9 provides a schematic diagram of a sensing system according to a further embodiment of the present invention;

FIG. 10 provides a schematic diagram of a sensing system according to a further embodiment of the present invention;

FIG. 11 provides a schematic diagram of a sensing system according to a further embodiment of the present invention;

FIG. 12 provides a schematic diagram of a sensing system according to a further embodiment of the present invention.

### DETAILED DESCRIPTION OF POSSIBLE EMBODIMENTS OF THE INVENTION

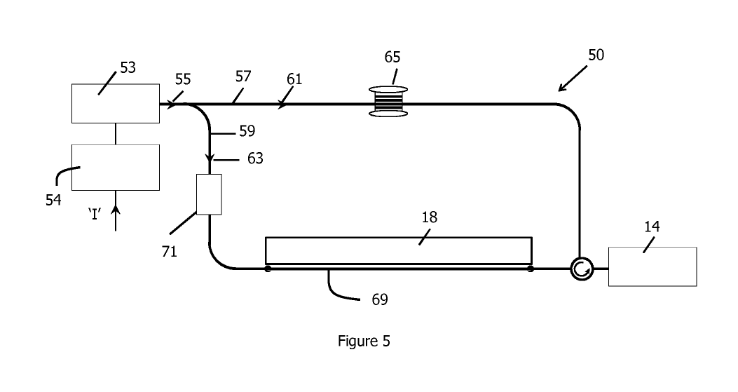

FIG. 5 illustrates a sensing system 50 according to a first embodiment of the present invention. The sensing system 50 comprises a coherent light source 53 which is driven by an injection current “I” to output a light signal 55.

The injection current “I” is modulated using aperiodic binary bit sequence(s) 54, so the optical frequency of the light signal 55 output from the light source 53 is modulated in time according to the aperiodic binary sequence(s) 54.

The aperiodic binary sequence(s) 54 will comprise N number of bits and each bit has a time duration of T thus ensures that the optical frequency of the light signal 55 is modulated at a frequency equal to 1/T (known as the modulation frequency f_{mod}). The aperiodic binary bit sequence(s) 54 preferably is periodically repeated and the total duration of the bit sequence(s), which is known as code length in prior art, is given as the product N×T. Then correlation peaks appear along the sensing fiber periodically with periodicity of 0.5×N×T. Like in conventional BOCDA sensing systems, the maximum achievable sensing range is determined by the distance between two adjacent correlation peaks, hence the parameters of N and T. The value of N and T are independent, so that they can be chosen so as to achieve a desired sensing range. Using the known velocity of light in a sensing optical fiber 69 of the system, the value of 0.5×N×T can be converted to distance, matching the desired sensing range. In this particular example the aperiodic binary sequence 54 is provided by a pseudo-random binary sequence generator (not shown).

The light source 53 is operated at a bias level. So, when the injection current is modulated by a binary bit of ‘0’ value, the light source 53 outputs a light signal 55 at optical frequency ν₁. However, when the injection current “I” is modulated by a binary bit of ‘1’ value, an increase in the injection current “I” causes a shift in the optical frequency of the output light signal 55. So, the light source 53 outputs a light signal 55 at optical frequency ν₂. Consequently, the frequency of the light signal 55 output of the light source is randomly swapped between the two frequencies: ν₁ and ν₂ at the modulation frequency f_{mod} (in other words, the clock rate) of the aperiodic binary sequence(s) 54 during the total length of the aperiodic binary sequence(s) 54.

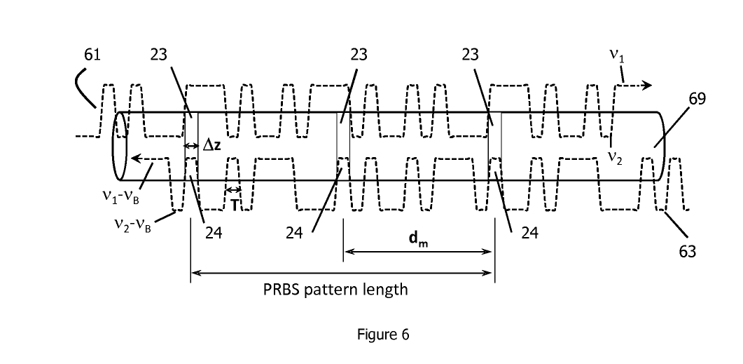

In this particular example the aperiodic binary sequence(s) 54 is a pseudo-random binary sequence (PRBS) modulation. However, it will be understood that any aperiodic binary sequence(s) 54 could be used. It will also be understood that any multi-level bit sequence could be used, and the invention is not limited to binary bit sequences. As shown in FIG. 6, the pseudo-random binary sequence (PRBS) modulation is repeated by the code length of the PRBS.

The sensing system 50 further comprises a means for splitting the light signal 55 which is output from the light source 53 (i.e. the randomly frequency-modulated light signal 55). In this example the frequency modulated light signal 55 is split between a first and second optical branch 57,59, to provide a pump signal 61 in the first branch 57 and a probe signal 63 in the second branch 59. As will be described in more detail later, the pump and the probe signals 61,63 could alternatively be generated by two distinct light sources.

A sensing optical fiber 69 is further provided in system 50; the first and second optical branches 57,59 each terminate at sensing optical fiber 69. The sensing optical fiber 69 is secured to a structure 18, so that temperature and strain within that structure 18 can be monitored.

It will be understood that a single or multiple aperiodic binary sequence(s) 54 (or any multi-level bit sequences) may be used; that means that the optical frequency of the pump signal 61 and probe signal 63 can be modulated separately. Thus, the optical frequency of light signal 55 is modulated using a single or multiple aperiodic binary sequence(s) 54, including any noise and/or chaotic sources.

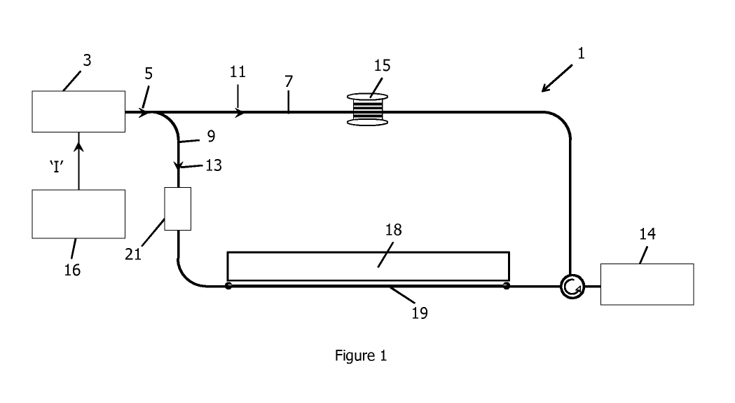

The sensing system 50 comprises a delay line 65 (e.g. a 1 km-long optical fiber). The delay line 65 can be placed in either the first branch 57 or the second branch 59, in order to make the optical path length of the first and second branches 57,59 differ. The pump signal 61 passes through a delay line 65 before being delivered to the sensing optical fiber 69. The delay line 65 will prevent the occurrence of a zeroth-order correlation peak in the same manner as disclosed for the sensing system 1 in FIG. 1. A zeroth-order correlation peak will occur if the optical path length of the first and second branches 57,59 are equal, and the delay line 65 ensures that this is not the case.

An external modulator 71 is provided along the second branch 59; the external modulator 71 will shift the frequency of the probe signal 63 so that the frequency of the probe signal 63 with respect to the pump signal 61 can be scanned in the vicinity of Brillouin frequency of the sensing fiber 69. When the difference between the frequency of the pump signal 61 and the frequency of the probe signal 63 is equal to the Brillouin shift of the sensing optical fiber 69 acoustic waves 24 are strongly generated and localized at a certain point (correlation peak 23) along the length of the sensing optical fiber 69. Thus, a single correlation peak is created along the length of the sensing optical fiber 69. The acoustic wave 24 generated at the correlation peak stimulates the Brillouin scattering from the pump signal 61 to the probe signal 63 (Brillouin gain configuration) or vice and versa (Brillouin loss configuration). As a result, the probe signal 63 experiences an optical amplification or attenuation depending on Brillouin gain or loss configuration, respectively. The optical gain or loss that the probe signal experienced through the SBS interaction with the pump signal 61 can be calculated from the ratio of the optical power of the amplified or attenuated probe signal 63 to the optical power of the initial probe signal 63 before the SBS process. The difference between the frequency of the pump signal 61 and the frequency of the probe signal 63 corresponding to the maximum Brillouin gain or loss that the probe signal 63 experienced is determined to be Brillouin frequency at the correlation peak 23 along the sensing fiber 19. The Brillouin frequency at the correlation peak can be determined, simply by scanning the frequency of the probe signal 63 with respect to the pump signal 61 and measuring the optical power of the probe signal 63, using optical power meter or photo-detector. As the frequency of the probe signal 63 is scanned, the optical power of the probe signal is monitored and measured for each frequency of the probe signal 63. The frequency of the probe signal 63 at which the probe signal 63 experiences a maximum optical amplification or attenuation occurs is used to determine the Brillouin frequency, of the sensing optical fiber 69 along the correlation peak 23 along the sensing fiber 69. The Brillouin frequency is determined as being the difference between the frequency of probe signal 63 at which maximum optical amplification or attenuation for the probe signal 63 occurred and the frequency of the pump signal 61. As previously explained, the SBS interaction between the pump signal 61 and the probe signal 63 can efficiently occur only in region where the correlation peak is present, so that the measured Brillouin frequency, referred to local Brillouin frequency, can represent the Brillouin frequency at the correlation peak 23. Using the known relationship between temperature and strain and Brillouin frequency (which was determined in a calibration step in which the sensing optical fiber was subjected to known temperatures and strains and the Brillouin frequency measured), the temperature and strain within the sensing optical fiber 69 at the correlation peaks 23 can be determined. The temperature and strain within the sensing optical fiber 69 at the correlation peaks 23 will correspond to the temperature and strain in the parts of the structure 18 which are adjacent the correlation peaks 23 to which the sensing optical fiber 69 is attached.

The position of the correlation peaks 23 are then shifted along the sensing optical fiber 69 by changing the modulation frequency f_{mod} and the Brillouin frequency at position of the shifted correlation peaks 23 is then determined by repeating the processes of scanning the frequency of the probe signal 63 and determining the frequency of the probe signal 63 at maximum optical gain or loss for the probe signal 63 occurs etc. These steps are repeated until the correlation peaks 23 have been shifted along the whole length of the sensing optical fiber 69 and the Brillouin frequency is determined at each iteration so that the distributed Brillouin frequency over the entire length of the sensing optical fiber 69 is obtained.

Using the linear relationship between Brillouin frequency and change of temperature and/or strain as previously described, any variation of temperature and/or strain to the structure can be monitored.

Absolute temperature and/or strain monitoring can be determined based on a pre-calibration process. A pre-calibration process may be carried out which comprises the step of setting the sensing optical fiber 69 to have a known temperature and measuring the Brillouin frequency of the sensing optical fiber 69 by the processes of scanning the frequency of the probe signal 63 with respect to the pump signal 61 and determining the frequency of the probe signal 63 at which maximum optical gain or loss for the probe signal 63 occurs. The pre-calibration process may further comprise the step of setting the sensing optical fiber 69 to have a known strain and measuring the Brillouin frequency of the sensing optical fiber 69 by the processes of scanning the frequency of the probe signal 63 with respect to the pump signal 61 and determining the frequency of the probe signal 63 at which maximum optical gain or loss for the probe signal 63 occurs. The pre-calibration process may comprise the step of setting the sensing optical fiber 69 to have a plurality of known strains and temperatures and for each strain and temperature measuring the Brillouin frequency of the sensing optical fiber 69 by the processes of scanning the frequency of the probe signal 63 with respect to the pump signal 61 and determining the frequency of the probe signal 63 at which maximum optical gain or loss for the probe signal 63 occurs. In each case the Brillouin frequency of the sensing optical fiber 69 is determined as being the difference between the frequency of probe signal 63 at which maximum optical gain or loss for the probe signal 63 occurred and the frequency of the pump signal 61. The calibration allows to determine the relationship between the Brillouin frequency of the sensing optical fiber 69 and the strain and temperature of the sensing optical fiber 69. Therefore, the measured Brillouin frequency can be converted to the absolute temperature and/or strain applied to the structure based on the linear response of Brillouin frequency to temperature and/or strain and Brillouin frequency at known temperatures. For example, the absolute temperature T can be calculated using the linear relationship of Brillouin frequency with respect to temperature C_{T} in unit of MHz/° C., and Brillouin frequency ν_{BTo} at known temperature Tₒ and Brillouin frequency ν_{BT} at temperature T, as follows:

T=C_{T}·(ν_{BT}−ν_{BTo})+Tₒ

The sensing system 50 further comprises a detector 14. The detector 14 is configured to receive the probe signal 63 after the SBS interaction with the pump signal 61 and to determine the Brillouin frequency, from which the temperature or the strain at the correlation peaks along the sensing optical fiber 69 can be computed.

FIG. 6 depicts the instantaneous frequency of the pump signal 61 and probe signal 63, while propagating through the sensing optical fiber 69. Correlation peaks 23 are formed at the regions where the differential frequency between the pump signal 61 and probe signal 63 remains constant and is equal to the Brillouin shift of the sensing optical fiber 69; strong acoustic waves 24 are generated at those positions. At the other portions along the length of the sensing optical fiber 69, the relative frequency between the pump and probe signals 61,63 varies in time, so acoustic waves are not sufficiently generated through the SBS (stimulated Brillouin scattering) interactions in regions outside the correlation peak positions 23. Thus, Brillouin measurements which are taken by the detector 14 will reflect conditions at the correlation peak positions 23.

During operation, localised acoustic wave along the sensing fiber 69 are set up due to the SBS interaction between the pump signal 61 and the probe signal 63. Localisation of the acoustic wave 24 is achieved due to the correlation between the frequency modulation patterns of the two signals. An acoustic wave 24 is formed by the interaction of the light of the pump signal 61 with the sensing optical fiber 69; this interaction causes molecular vibrations within the sensing optical fiber 69, and these molecular vibrations propagate along the sensing optical fiber 69 to define an acoustic wave which has a frequency equal to the Brillouin frequency of the sensing optical fiber 69. Regions along the length of the optical sensing fiber 69 where the difference between the frequency of the probe signal 63 and the frequency of the pump signal 61 is constant and is equal to the Brillouin frequency of the sensing optical fiber 69 are known as correlation peaks 23; at the correlation peaks the optical interference between the pump signal 61 and the probe signal 63 generates a beating signal at differential frequency between the pump signal 61 and the probe signal 63, which reinforces the acoustic wave 24, so as to stimulate the Brillouin scattering process from the pump signal 61 to the probe signal 63 or vice and versa. Thus, at the correlation peaks the frequency difference between the Brillouin pump and probe signals 61,63 remains constant at Brillouin frequency shift, so strong acoustic waves 24 can be created at correlation peaks 23 through the sufficient SBS interaction. In the region of the sensing optical fiber 69 where a correlation peak 23 is located, an acoustic wave is present, which manifests an optical gain or loss for the probe signal 63 so that it can be used for Brillouin analysis to determined properties such as temperature and strain which are present in the sensing optical fiber 69 at the correlation peaks 23. The temperature and strain in the sensing optical fiber 69 will reflect the temperature and strain within the structure 18 to which the sensing optical fiber 69 is attached and/or the peripheral temperature and strain around the structure 18.

At regions along the sensing optical fiber 69 which are outside of the correlation peaks the difference between the pump and probe signals 61,63 varies and is not constant; therefore the acoustic wave 24 is not sufficiently stimulated at the regions outside of the correlation peaks 23. On the contrary, along the remaining part of the sensing fiber, the acoustic waves cannot be sufficiently activated since the differential frequency between the pump and probe signal 61,63 is flipped between two conditions: SBS resonance condition (when the frequency difference between the pump and probe is within the Spectral width of stimulated Brillouin scattering) and SBS off-resonance condition (when the frequency difference between the pump and probe is not within the Spectral width of stimulated Brillouin scattering. Accordingly in order to carry out Brillouin analysis over the whole length of the sensing optical fiber 69 the position of the acoustic wave 24 should be moved along the length of the optical sensing fiber 69.

As injection current “I” to the light source 53 is modulated by the aperiodic sequence 54, the light signal 55 output from the light source 53 will also be modulated. The frequency modulation of the output light signal 55 will ensure that correlation peaks 23 are created in the sensing fiber 69 by means of acoustic waves generation, so that temperature and strain measurement can be taken at correlation points by scanning the frequency of the probe signal 63 referred to as Brillouin analysis.

The frequency modulation of the light signal 55 is configured to move the correlation peaks 23 along the length of the optical sensing fiber 69 so that successive measurement of Brillouin analysis to determine properties such as temperature and strain at successive correlation peaks can be carried out, so as to measure a distributed temperature and strain along portions or the whole length of the sensing fiber 69.

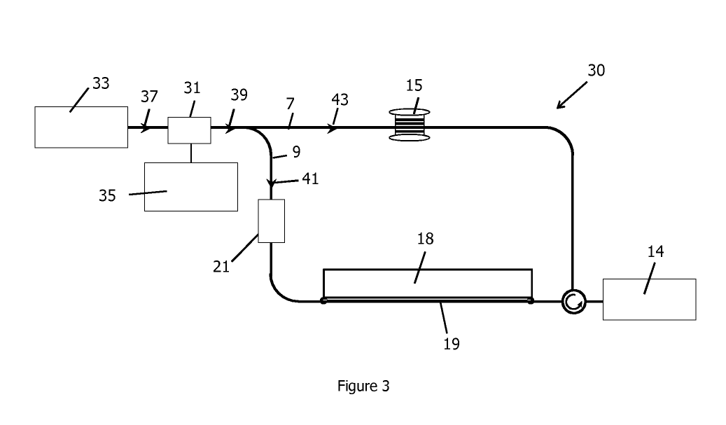

The spatial resolution Δz and the sensing range dₘ of the sensing system 50 are identical to that of the sensing system 30 shown in FIG. 3 but without the need for an external electro-optic phase modulator. Specifically the spatial resolution Δz is given as:

Δz=0.5×V_{g}×T

dₘ=0.5×N×V_{g}×T

V_{g} is the light signal velocity in the sensing optical fiber 19, T is time duration of a bit in PRBS and N is the number of bits.

The spatial resolution Δz and the sensing range dₘ of the sensing system 50 are determined by the modulation properties of PRBS even though no EOM is used. The injection current modulation using an aperiodic binary sequence makes the sensing range and the spatial resolution independent of one another, so that the sensing range can be enhanced while preserving a high spatial resolution. The present invention is based on the optical frequency correlation between the pump and the probe signals like conventional BOCDA technique, instead of the optical phase correlation between them, which requires additional electro-optic components and/or electrical components, to overcome the trade-off relations in typical BOCDA systems.

In sensing system 50 the modulation depth, defined as the amount of the frequency modulation of either the pump and or the probe, does not have any impact on the spatial resolution, so it can be set at any value. But, it must be larger than the spectral width of the intrinsic Brillouin gain spectrum, typically about 30 MHz in order to minimize the magnitude of residual acoustic waves along the sensing fiber, hence maximizing the signal to noise ratio (Spectrum of Brillouin scattering has a finite bandwidth with a bell-shape (normally Lorentzian or Gaussian shape). The spectral width at full with at half maximum is typically 30 MHz. The peak frequency of the Brillouin scattering spectrum is defined as Brillouin frequency). For instance, a small modulation depth of 1-2 GHz can be suitable for this type of sensing system, which doesn't suffer from any problems in terms of optical filtering and spectral overlapping of the pump and probe signals, which act as actual limitations in conventional BOCDA sensing systems.

The sensing system 50 also overcomes the limitations of requiring an RF amplifier or for π-phase control, and the problem of the conversion of optical phase modulation through an external phase-EOM to intensity modulation, because the light signal 55 is not influenced by the dispersion of the sensing fiber 69.

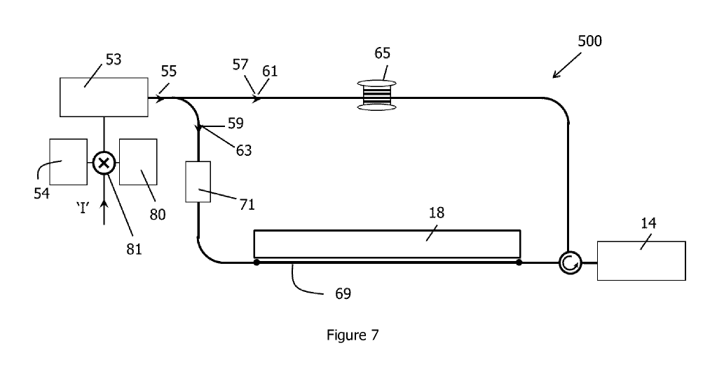

FIG. 7 shows a sensing system 500 according to a further embodiment of the present invention. The sensing system 500 has many of the same features as the sensing system 50 shown in FIG. 5 and like features are awarded the same reference numbers. As shown in FIG. 7, the sensing system 500 further comprises a means for multiplying 81 the aperiodic binary sequence(s) 54 with an aperiodic bit sequence 80 having “k” amplitude levels, wherein “k” is an integer larger than two. The injection current “I” used to operate the light source 53 is modulated by the product of the PRBS 54 and an aperiodic bit sequence 80 having “k” amplitude levels, as shown in FIG. 7. In this configuration, the probability of frequency of the pump and probe signals 61,63 matching in regions outside of the correlation peaks 23 can be significantly reduced, while the acoustic wave 24 strength at correlation peaks is preserved. Thus, improved signal-to-noise ratio, and thus improved sensing performances, can be achieved.

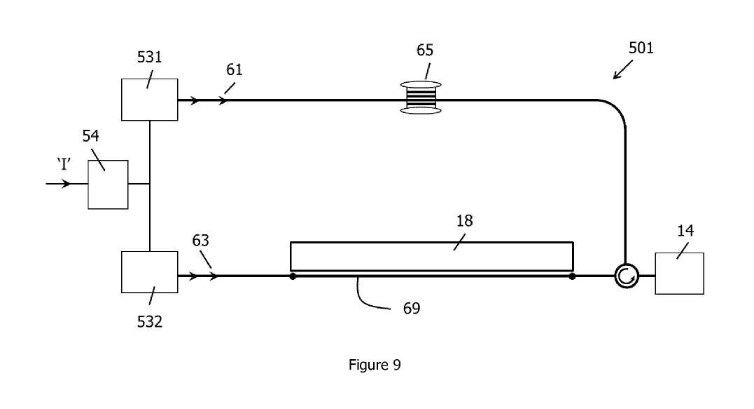

FIG. 9 illustrates a sensing system 501 according to a further embodiment of the present invention. The sensing system 501 has many of the same features as the sensing system 50 illustrated in FIG. 5 and like features are awarded the same reference numbers. The sensing system 501 also operates in a similar manner to sensing system 50.

However, unlike the sensing system 50 in the sensing system 501 the light signal 55 output from the light source 53 is not split to provide the pump and probe signals 61,63. The sensing system 501 comprises a first coherent light source 531 and a second coherent light source 532 which are each driven by a common injection current “I”. The injection current “I” is modulated using aperiodic binary sequence 54 so that the light signal output from each of the first coherent light sources 531 and a second coherent light source 532 are frequency modulated. The frequency modulated light signal which is output from the first coherent light source 531 defines the pump signal 61 and the frequency modulated light signal which is output from the second coherent light source 532 defines the probe signal 63. In the sensing system 501 the a first coherent light source 531 and a second coherent light source 532 are each driven by a common injection current “I”. A single aperiodic binary sequence 54 is used to modulate the injection current “I”; in this example the single aperiodic binary sequence 54 is a single Pseudo-random binary sequence (PRBS).

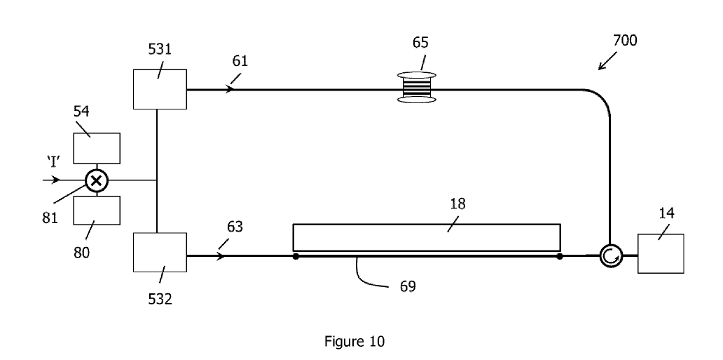

FIG. 10 illustrates a sensing system 700 according to a further embodiment of the present invention. The sensing system 700 comprises many of the same features of the sensing system 501 illustrated in FIG. 9 and like features are awarded the same reference numbers. The sensing system 700 also operates in a similar manner to the sensing system 501.

As shown in FIG. 10, the sensing system 700 further comprise a means for multiplying 81 the aperiodic binary sequence 54 with an aperiodic bit sequence 80 having “k” amplitude levels, wherein “k” is an integer larger than two. The common injection current “I” which drives both the first coherent light source 531 and a second coherent light source 532 is thus modulated by the product of the PRBS 54 and the aperiodic bit sequence 80 having “k” amplitude levels. In this configuration, the probability of frequency of the pump and probe signals 61,63 matching in regions outside of the correlation peaks 23 can be significantly reduced, while the acoustic wave 24 strength at correlation peaks is preserved. Thus, improved signal-to-noise ratio, and thus improved sensing performances, can be achieved.

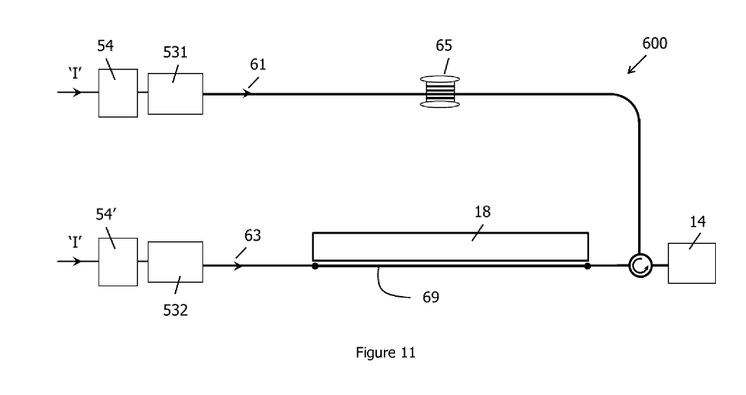

FIG. 11 illustrates a sensing system 600 according to a further embodiment of the present invention. The sensing system 600 comprises many of the same features of the sensing system 501 illustrated in FIG. 9 and like features are awarded the same reference numbers. The sensing system 600 also operates in a similar manner to the sensing system 501.

In the sensing system 600 the first coherent light source 531 and a second coherent light source 532 are each driven by distinct, independent, injection currents I,I′. The first coherent light source 531 is driven by an injection current “I” and the second coherent light source 532 is driven by a second injection current “I′”.

A first aperiodic binary sequence 54 is used to modulate the first injection current “I”, and a second aperiodic binary sequence 54′ is used to modulate the second injection current “I′”.

In this example the first aperiodic binary sequence 54 and second aperiodic binary sequence 54′ are each Pseudo-random binary sequences (PRBS) and both the first aperiodic binary sequence 54 and second aperiodic binary sequence 54′ are the same.

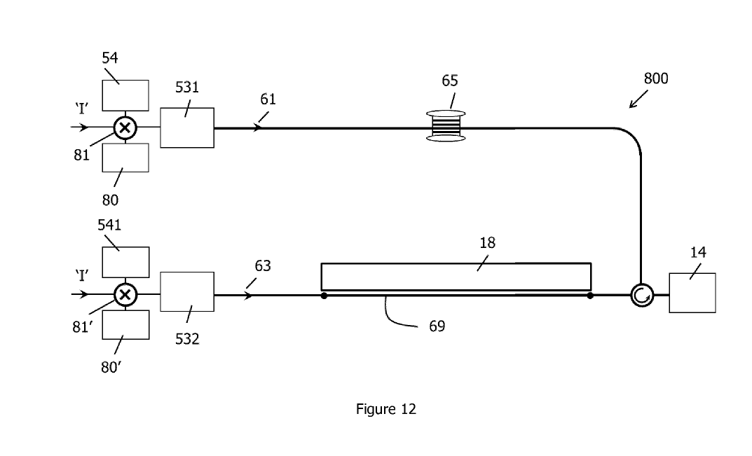

FIG. 12 illustrates a sensing system 800 according to a further embodiment of the present invention. The sensing system 800 comprises many of the same features of the sensing system 600 illustrated in FIG. 11 and like features are awarded the same reference numbers. The sensing system 800 also operates in a similar manner to the sensing system 600.

As shown in FIG. 12, the sensing system 800 further comprises a means for multiplying 81 the first aperiodic binary sequence 54 with a first aperiodic bit sequence 80 having “k” amplitude levels, wherein “k” is an integer larger than two, and a means for multiplying 81′ the second aperiodic binary sequence 54′ with a second aperiodic bit sequence 80′ having “k” amplitude levels, wherein “k” is an integer larger than two. The first injection current “I” which drives the first coherent light source 531 is thus modulated by the product of the first PRBS 54 and the first aperiodic bit sequence 80 having “k” amplitude levels. The second injection current “I′” which drives the second coherent light source 532 is thus modulated by the product of the second PRBS 54′ and the second aperiodic bit sequence 80′ having “k” amplitude levels. In this example both the first PRBS 54 and second PRBS 54′ are equal, and the first and second aperiodic bit sequences 80,80′ are equal. In this configuration, the probability of frequency of the pump and probe signal 61,63 matching in regions outside of the correlation peaks 23 can be significantly reduced, while the acoustic wave 24 strength at correlation peaks is preserved. Thus, improved signal-to-noise ratio, and thus improved sensing performances, can be achieved.

In the embodiments shown in FIGS. 9-12 i.e. those embodiments which use two lasers to provide pump and probe signal, the initial frequency of the two respective lasers can be set at two different values. The frequency offset between the two lasers can be set close to Brillouin frequency. Accordingly no frequency shifter is required. Due to the current modulation, the frequency modulation pattern for the two lasers is the same.

Various modifications and variations to the described embodiments of the invention will be apparent to those skilled in the art without departing from the scope of the invention as defined in the appended claims. Although the invention has been described in connection with specific preferred embodiments, it should be understood that the invention as claimed should not be unduly limited to such specific embodiment.

1. A method of performing a distributed sensing measurement, comprising the steps of,
modulating the frequency of one or more light signals output from one or more light sources, using one or more multi-level sequence of bits so that the one or more light signals are frequency modulated;
using the one or more frequency modulated light signals to provide a pump signal and a probe signal;
propagating the pump and probe signals along an optical fiber;
using interactions between the pump and probe signal to perform a distributed sensing measurement.

2. A method according to claim 1 wherein the method comprises the step of modulating the frequency of a light signal output from a single light source using a multi-level sequence of bits so that the light signal is frequency modulated to provide a frequency modulated light signal; and wherein the step of using the one or more frequency modulated light signals to provide a pump signal and a probe signal comprises splitting said frequency modulated light signal to provide a pump signal and a probe signal.

3. A method according to claim 1 wherein the method comprises the step of modulating the frequency of a first light signal output from a first light source using a first multi-level sequence of bits to provide a first frequency modulated light signal, and modulating the frequency of a second light signal output from a second light source using a second multi-level sequence of bits, to provide a second frequency modulated light signal; using the first frequency modulated light signal as the pump signal and using the second frequency modulated light signal as the probe signal.

4. A method according to claim 3 wherein the first multi-level sequence of bits is equal to the second multi-level sequence of bits.

5. A method according to claim 1 further comprising the step of shifting the frequency of the probe signal and/or pump signal so that the frequency difference between the probe and pump signal is equal to a Brillion frequency of the sensing optical fiber.

6. A method according to claim 1 wherein the step of modulating the frequency of the one or more light signals comprises intermittently modulating the frequency of the one or more light signals.

7. The method according to claim 1 wherein the multi-level sequence of bits comprises a binary aperiodic sequence of bits.

8. A method according to claim 1, wherein the step of modulating the frequency of the light signal output from a light source comprises modulating an injection current used to operate said light source, using a multi-level sequence of bits.

9. A method according to claim 1, wherein the step of modulating the frequency of a light signal output from a light source comprises using a frequency shifter, which can shift the frequency of the light signal output from said light source, using the multi-level sequence of bits.

10. A method according to claim 1 further comprising the step of multiplying the multi-level sequence of bits with an aperiodic sequence comprising ‘k’ amplitude levels, wherein ‘k’ is an integer greater than two.

11. A method according to claim 1 wherein the step of using interactions between the pump and probe signal to perform a distributed sensing measurement comprises Brillouin scattering analysis.

12. A method according to claim 1 further comprising the step of delaying the pump signal or probe signal to provide higher order correlation peaks.

13. A sensor system for performing a distributing sensing measurement, the sensor comprising,
a light source;
a means for modulating the frequency of a light signal output from the light source using one or more multi-level sequence of bits, so that the light signal is frequency modulated;
a means for splitting the frequency modulated light signal to provide a pump signal and a probe signal;
a sensing optical fiber through which the pump signal and probe signal can propagate;
a detection means which is configured to perform distributed sensing measurements based on interactions between the pump signal and probe signal in the sensing optical fiber.

14. A sensor system for performing a distributing sensing measurement, the sensor comprising,
a first and second light source;
a means for modulating the frequency of a first light signal output from a first light source, using a first multi-level sequence of bits, to provide a pump signal;
a means for modulating the frequency of a second light signal output from a second light source, using a second multi-level sequence of bits, to provide a probe signal;
a sensing optical fiber along which the pump signal and probe signal can propagate;
a detection means which is configured to perform distributed sensing measurements based on interactions between the pump signal and probe signal in the sensing optical fiber.

15. A sensor system according to claim 13 wherein the system comprises, a light source operable by an injection current to output the light signal output, the frequency of the light signal output being a function of the injection current, and wherein the means for modulating the frequency of the light signal output comprises a modulator which is configured to modulate the injection current provided to the light source using the multi-level sequence of bits, so that the light signal output which is output from the light source is frequency modulated.
